(19) United States
(12) Patent Application Publication
(10) Pub. No.: US 2025/0092819 A1
(43) Pub. Date: Mar. 20, 2025

(54) Dual piston based gensets for vehicle electrification

(71) Applicant: Xubin Song, Bloomfield Hills, MI (US)

(72) Inventor: Xubin Song, Bloomfield Hills, MI (US)

(21) Appl. No.: 18/368,672

(22) Filed: Sep. 15, 2023

(51) Int. Cl. F02B 75/30; F02B 41/04; F02B 63/04; F02B 75/04; F02B 75/18; F02B 75/28; H02K 7/116; H02K 7/18

(52) U.S. Cl. CPC F02B 75/30; F02B 41/04; F02B 63/04; F02B 75/045; F02B 75/18; F02B 75/287; H02K 7/116; H02K 7/1815

(57) ABSTRACT

This invention presents an innovative technology, dedicated hybrid cycle, for dual piston based engines, which can be further developed as mobile chargers for electric vehicles. This design re-defines the single engine piston/crankshaft configuration in conventional internal combustion engines as two sets per the combustion process: Otto piston and Atkinson piston; correspondingly, there are Otto crankshaft and Atkinson crankshaft. As a matter of fact, the Atkinson crankshaft can be realized through a cam as well. The Atkinson mechanism is dedicated to accomplish high combustion efficiency, while the Otto crankshaft for engine output only. Periodically, the hybrid combination of both Atkinson and Otto cycle can significantly improve the engine efficiency and torque density. This innovative combustion mechanism is further developed for genset applications to generate electricity on the vehicles in a most efficient manner.

### 1. BACKGROUND OF THE INVENTION

Battery based electrification of light-duty cars and vehicles has gained trending advantage for commercialization at scale. For battery electric vehicles (BEV), HVAC (Heating, Ventilation, and Air Conditioning) needs to consume electricity for cabin comfort. Moreover, environmental temperatures at either extreme cold or hot conditions can deteriorate the battery performance significantly. Thus, BEVs have range anxiety overall. The low energy density of the today's battery poses another road block for electrifying commercial vehicles, especially those which have long hour usage per daily operations (such as long-haul or work trucks). Probably there will be a lack of charging infrastructure with costly stationary charging stations for the upcoming decades. Range extenders are developed dominantly by applying the four stroke engines available in the market. SI (spark ignition) is used for petrol engines with the Otto Cycle, while CI (compression ignition) with the Diesel Cycle. Either cycle has low power performing characteristics, because one power stroke per two revolutions of the engine crankshaft. Since the Otto cycle has equal stroke operation with the piston movements (referring to intake, compression, expansion/power, and exhaust), the combustion efficiency is hard to be improved. EGR (exhaust gas recirculation) complicates the engine design, though contributing to engine performance improvement. Since two stroke engines have high emissions and low durability & reliability, they are not used for the automotive industry.

### 2. SUMMARY OF THE INVENTION

This patent presents an innovative technology approach, “dedicated hybrid cycle (DHC)”, as a prospective motive electricity generation approach for EVs by significantly boosting the brake thermal efficiency of the internal combustion engines. The piston is designed to have two pieces, Otto piston piece and Atkinson piston piece. The Otto piece is connected to the crankshaft as the output-shaft of a conventional four-stroke engine, while the Atkinson piece is designed to accommodate a longer power stroke than the compression stroke with an independent piston movement from the Otto piston piece. The top dead centers for both Otto and Atkinson piston can be different so that the burnt gas retention can be used to replace external EGR mechanism. SI and CI can be applied principally for combustion ignition as designed. Its exemplary layout goes through a genset, which can work as a mobile charger for BEVs. The synergy of DHC and carbon-neutral alternative fuels (such as bio-fuels, synthetic fuels, and e-fuels) can be a practical solution for electrifying hard-to-abate vehicles. This proposed genset, range extender (RE), can be optimized to produce the most efficient fuel-to-electricity conversion while minimizing both carbon dioxide and harmful emissions in comparison to conventional four stroke engines.

### 3. BRIEF DESCRIPTION OF THE DRAWINGS

FIG. 1 presents a single cylinder configuration with the crankshaft-based dual piston for internal combustion engines. FIG. 2 depicts the layout and mechanism of the Atkinson crankshaft with the Atkinson piston. In FIG. 3, another innovative implementation of the dual piston is carried out for a single cylinder configuration through a cam device, Atkinson cam. FIG. 4 presents further layout with both Atkinson piston and Atkinson cam. Based on the dual-piston mechanism, FIG. 5 extrapolates the TDC (top dead center) and BDC (bottom dead center) of both Otto and Atkinson piston during the combustion process. FIG. 6 presents two possible configurations of gensets, one with speed increaser gear and the other one without (i.e., direct connection between a motor and the Otto crankshaft).

### 4. DETAILED DESCRIPTION OF THE INVENTION

This invention provides two designs to implement the dual piston for four-stroke internal combustion engines. With two pistons inside the engine cylinders, there are two sets of crankshaft mechanisms correspondingly to accomplish the combustion process. The idea is illustrated through a single cylinder configuration of an internal combustion engine. This mechanism can be easily extended to multiple cylinder engines with spark ignition (SI) or compression ignition (CI).

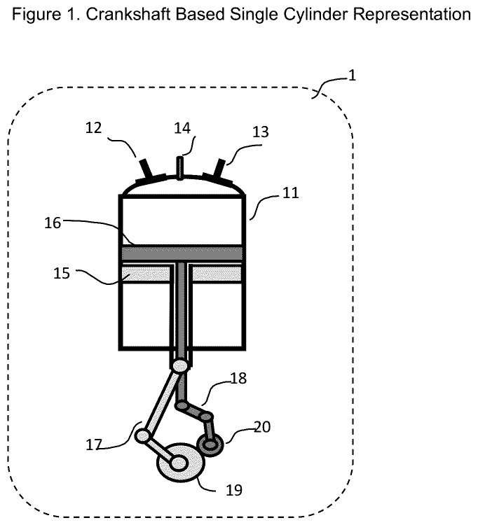

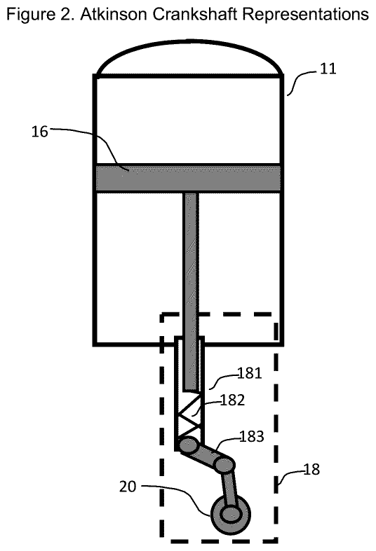

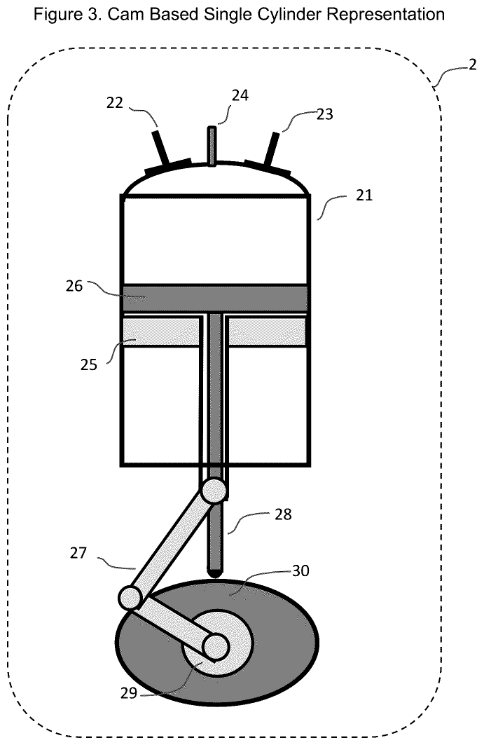

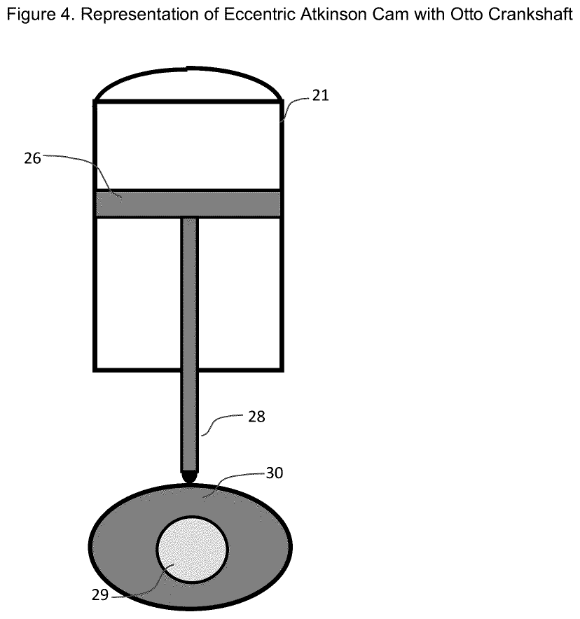

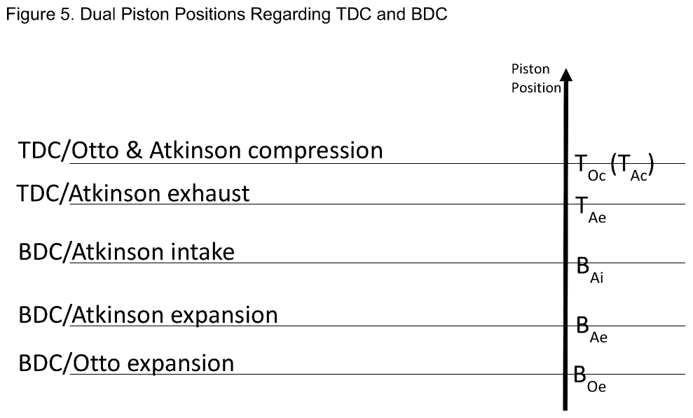

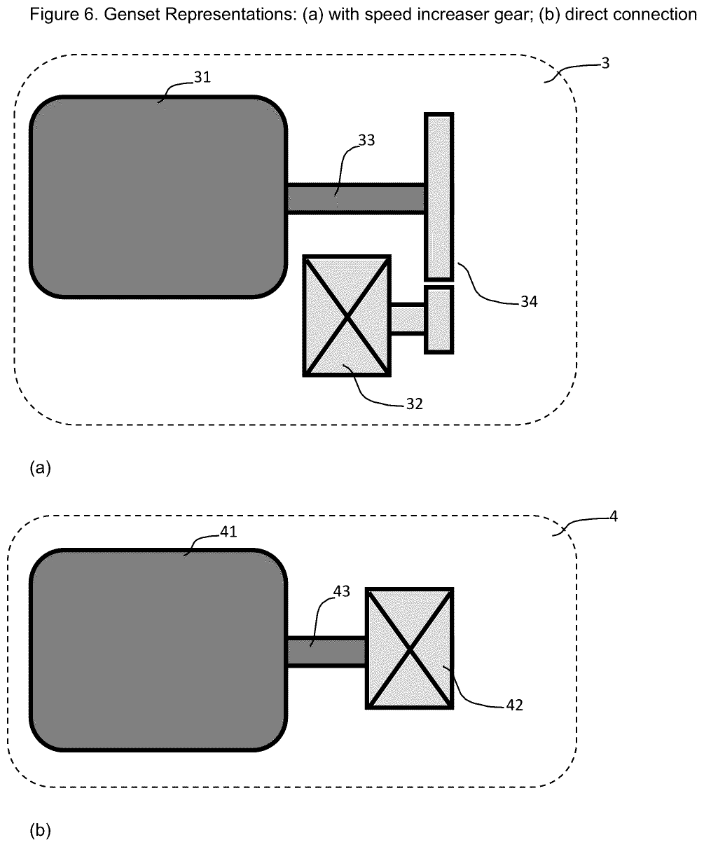

The first design is shown in FIG. 1 as a single cylinder engine 1 with the engine cylinder 11. The Otto mechanism consists of Otto piston 15 and Otto crankshaft 17. Going through the gearing pair of the speed increaser gears 19 and 20 (which can be set a ratio of ½), the Atkinson mechanism of Atkinson piston 16 and Atkinson crankshaft 18 can run twice faster than the Otto mechanism. It is worth noting that the gear 19 is installed on the engine output shaft. This single cylinder engine embodies intake valve 12 and exhaust valve 13 with a spark plug 14. Simply to remove the spark plug 14, then this single cylinder engine can work as a CI engine.

FIG. 2 further explains the composition of the Atkinson crankshaft 18, which works together with the Atkinson piston 16 within the engine cylinder 11. Due to the speed increaser gear 20, the crankshaft 183 can push the spring 182 upward inside a sliding cylinder 181 so that the Atkinson piston 16 can move upward for the volume compression. In the other way, the Atkinson piston 16 can be pulled down as expansion because of the motion of the crankshaft 183. Therefore, the compression and expansion have different stroke displacements.

The other dual piston design is presented in FIG. 3 as a single cylinder engine 2, which has a layout similar to the engine 1 in FIG. 1. The engine has intake valve 22 and exhaust valve 23 with a spark plug 24. Without the spark plug 24, the engine 2 can work as a CI engine too. The Otto piston 25 moves forcibly with the Otto crankshaft 27, which is attached on an engine output-shaft 29. An ellipse-shaped cam 30 is fixed concentrically on the output-shaft 19. The cam 30 works together with the Atkinson shaft 28 to move the Atkinson piston 26 up and down. FIG. 4 further simplifies the composition of the engine cylinder 21, hosting the Atkinson piston 26 and the Atkinson shaft 28. The Atkinson cam 30 rotates together with the engine output-shaft 29. Thus, the Atkinson piston 26 can move to different positions according to the four-stroke combustion process such as intake, compression, expansion, and exhaust.

In FIG. 5, the positions of these two pistons are further exemplified to disclose the working mechanism of the dual-piston based engines. During the compression stroke, both Otto and Atkinson pistons can reach the TDC (top dead center), Toc (i.e., T_{AC}), simultaneously. Afterwards, the Otto piston moves to the Otto expansion BDC (bottom dead center, B_{Oe}), and in the meanwhile the Atkinson piston quickly moves to complete the movements to the Atkinson expansion B_{Ae}, and then the Atkinson exhaust TDC (top dead center, T_{Ae}). With the Atkinson piston moves to the Atkinson intake position B_{Al} and then both pistons move together to the TDC with a complete compression. It is clear that the Atkinson expansion can be designed to have a longer stroke than the Atkinson intake stroke. Thus, the combustion efficiency can be significantly improved in an optimized manner.

One of the significant applications of these dual-piston engines is to develop motive gensets for assisting vehicle electrification. Such gensets can be deployed as stationary electricity generators as well. FIG. 6 gives out two genset configurations 3 and 4. Genset 3 has included a speed increaser gear 34 on the engine output-shaft 33 between the engine 31 and the generator/motor 34. The other genset 4 has a direct connection through the output-shaft 43 between the engine 41 and the generator/motor 44. The speed increaser gear might be able to improve the genset efficiency in an optimized manner.

### REFERENCES

1. Atkinson, J., “Gas engine”, U.S. Pat. No. 336,505, Feb. 16, 1886
2. Atkinson, J., “Gas engine”, U.S. Pat. No. 367,496, Aug. 2, 1887
3. Yan, M. J., “Accommodating Piston Seat for Differential-stroke cycle engines,” U.S. Pat. No. 8,739,754 B2, Jun. 3, 2014
4. Yan, M. J., “Accommodating Piston Seat for Differential-stroke cycle engines,” U.S. Pat. No. 9,133,763 B2, Sep. 15, 2015
5. Song, X., Prucka, R., Spitas, C., And Mohammadpour, M., “Editors' Perspectives: Synergistic Technologies For Dedicated Hybrid Powertrains,” International Journal Of Powertrains (IJPT), Vol. 10, No. 4, 2021, 395-439, DOI: 10.1504/UJPT.2021.10045243
6. Vishnu Nair, Gary Rogers, “Gasoline Engine Technologies for Revised 2023 and Later Model Year Light-Duty Vehicle Greenhouse Gas Emission Standards,” Final Report, Roush, Sep. 24, 2021

1. The single cylinder engine can be easily extended to multiple cylinder engines with either spark ignition (SI) or compression ignition (CI).

2. Dual piston mechanisms can be applied to improve the brake thermal efficiency of internal combustion engines and torque capacity especially at low speeds regardless of stoichiometric combustion, lean burn, spark ignition (SI) or compression (CI).

3. Both the Atkinson crankshaft and the Atkinson cam are designed to create longer expansion stroke than intake stroke. Thus, the Atkinson cycle (and Miller cycle) can be realized in the most efficient way per the first principle.

4. The Atkinson exhaust position can be designed to accommodate BGR (burnt gas retention), which might replace EGR (exhaust gas recirculation) functionally.

5. Dependent on the fuel used and the fuel properties, dual piston engines can be designed to accommodate LTC (low temperature combustion) with BGR features.

6. Regarding SI combustion, this dual piston engine can further boost both the power density and the efficiency with lean burn.

7. Either of these two Atkinson mechanisms can be applied to work as a single piston engine.

8. Variations of the dual piston applications based on the above description are claimed accordingly, but not limited to.
